(19) United States
(12) Patent Application Publication
(10) Pub. No.: US 2018/0285966 A1
(43) Pub. Date: Oct. 4, 2018

(54) Book self-borrowing system and method

(71) Applicants: Yijun XU, Suzhou (CN); Yijie XU, Suzhou (CN)

(72) Inventors: Yijun XU, Suzhou (CN); Yijie XU, Suzhou (CN)

(21) Appl. No.: 15/498,483

(22) Filed: Apr. 27, 2017

(30) Foreign Application Priority Data
Mar. 30, 2017 (CN) 201710204054.3

(51) Int. Cl. G06Q 30/06; G06Q 10/10; G06Q 30/04; G07C 9/00

(52) U.S. Cl. CPC G06Q 30/0645; G06Q 10/1097; G07C 9/00174; G06Q 30/0631; G06Q 30/04

(57) ABSTRACT

The present invention discloses a book self-borrowing system and method. The system includes a bookcase device, a client terminal and a network control device, the network control device being connected to the client terminal, the network control device being connected to the bookcase device, and the bookcase device including a book borrowing module, a book returning module, a book sharing module and a timing module. A user can place an idle book at the bookcase device, so that a personal idle book can be read more times via the bookcase device, which improves the usage rate of the idle book.

### CROSS REFERENCE TO RELATED APPLICATIONS

This application is bawd upon and claims priority to Chinese Patent Application No. 2017102040543 tiled on Mar. 30, 2017, the entire contents of which are incorporated herein by reference.

### TECHNICAL FIELD

The present invention relates to the field of book borrowing, and in particular to a book self-borrowing system and method.

### BACKGROUND

As it is well known, the experience of reading paper books cannot be replaced by electronic books, and therefore reading paper hooks is still the best way for people to acquire knowledge at present. However, the recycling of personally owned books hardly exists, and borrowing books is also relatively complicated. In addition, the existing book borrowing system and bookcase do not provide the function of recycling idle books of users, which results in a problem of reducing the usage rate of personal idle books because the personal idle books cannot be shared to the public.

### SUMMARY OF THE INVENTION

In order to overcome the deficiency of the prior art, the objective of the present invention is to provide a book self-borrowing system and method, which can solve the problem of a low usage rate of the personal idle books.

The objective of the present invention is implemented using the following technical solutions:
a book self-borrowing system, characterized in that: the system comprises a bookcase device, a client terminal and a network control device, the network control device bung connected to the client terminal, the network control device being connected to the bookcase device, and the bookcase device comprising a book borrowing module, a book returning module, a book sharing module, a timing, module and a storage module;
the book borrowing module comprises a recommendation unit, a search unit and a borrowing unit, the recommendation unit is used for performing book popularity ranking according to the number of times books were borrowed, and screening out a recommended book according to the book popularity ranking; the search unit is used for searching for a book desired by a user and locating the position of the book; the borrowing unit is used for performing identity information authentication on the user and controlling an intelligent bookcase to unlock an electronic lock, so that the user obtains the book and returns a book;
the book returning module comprises a reminding unit, an appointment unit and a scanning unit; the reminding module is used for reminding a user to return a book; the appointment unit is used for looking for an idle intelligent bookcase and making an appointment for returning; the scanning unit is used for scanning identity information about a returned book;
the book sharing module comprises an input unit, a check and approval unit and a storage unit; the input unit is used for inputting identity information about an idle book that needs to be shared by a user to obtain idle book information; the check and approval unit is used for checking and approving the idle book information and screening out qualified idle book information; the storage unit is used for storing the qualified idle hook information which has been screened out; and
the timing module is used for timing and calculation of book borrowing time.

Preferably, the book borrowing module further comprises a registration unit, the registration unit being used for performing initial registration on identity information about a book which has been put into circulation.

Preferably, the book returning module comprises a settlement unit, the settlement unit being used for settling an amount that needs to be paid according to book borrowing time.

Preferably, the bookcase device comprises a customer service module, the customer service module comprising a problem receiving unit and a problem solving unit, the problem receiving unit being used for receiving a problem feedback by a user and sending same to the problem solving unit, and the problem solving unit being used for receiving the problem feedback by the user and sending same to system maintenance personnel.

Preferably, the bookcase device comprises a device diagnosis module and an encouragement module, the device diagnosis module being used for autonomously diagnosing a system failure, and the encouragement module being used for querying the number of times a user borrows books and the number of idle books shared by the user via the book borrowing module and the book sharing module, and performing an encouragement operation on the user according to the number of times the user borrows books and the number of idle books shared by the user, the encouragement operation being prolonging free book borrowing time of the user.

According to a second aspect of the embodiments of the present disclosure, a book self-borrowing method is provided, characterized by comprising:
a user checking the location of a desired book via a client terminal or initiatively choosing the desired book at a bookcase device:
the user performing identity information authentication via the bookcase device, a network control device controlling a bookcase to unlock an electronic lock after the identity authentication is passed, and the user acquiring the book;
the bookcase device reminding the user to return a book via the client terminal, the user looking for an idle bookcase and performing an appointed hook returning operation, when the user returns the book, the bookcase device performing identity information authentication on the user, the network control device controlling an appointed bookcase to unlock an electronic lock after the identity information authentication is passed, and the user putting the book in the bookcase and completing a book returning operation; and
the user inputting identity information about an idle book that needs to be shared to obtain idle book information, the bookcase device checking and approving the idle book information and screening out qualified idle book information, and the bookcase device putting the idle hook corresponding to the qualified idle book information into circulation.

Preferably, the bookcase device performing initial registration on a book which has been put into circulation, the initial registration comprising a cover photo, table of contents and identification code of the hook and a book location, and storing the cover photo, table of contents, identification code and book location.

Preferably, the user looking for an idle bookcase via the client terminal and performing an appointed book returning operation, comprising, the user logging in the client terminal and sending an idle bookcase look-for instruction and an appointed returning instruction to the client terminal, and the client terminal sending an idle bookcase instruction and the appointed returning instruction to the bookcase device via the network control terminal.

Preferably, when the network control terminal controls a bookcase device to unlock an electronic lock, the bookcase device starting a timing operation, when the network control device controls an appointed bookcase to unlock an electronic lock, the bookcase device stopping the timing operation and calculating book borrowing time, and the bookcase device settling an amount that needs to be paid according to the book borrowing time.

Preferably, the user viewing a recommended book of the bookcase device via the client terminal, and determining a desired book according to the recommended book.

Compared to the prior art, the beneficial effects of the present invention are as follows: A user can place an idle book at the bookcase device, so that a personal idle book can be read more times via the bookcase device, which improves the usage rate of the idle book.

### BRIEF DESCRIPTION OF THE DRAWINGS

FIG. 1 is a module diagram of a book self-borrowing system in a preferred embodiment of the present invention.

FIG. 2 is a module diagram of a book self-borrowing system in a preferred embodiment of the present invention.

FIG. 3 is a module diagram of a book self-borrowing system in a preferred embodiment of the present invention.

FIG. 4 is a flow chart of a book self-borrowing method in a preferred embodiment of the present invention.

### DETAILED DESCRIPTION OF THE INVENTION

The present invention is further described below in conjunction with the accompanying drawings and specific embodiments.

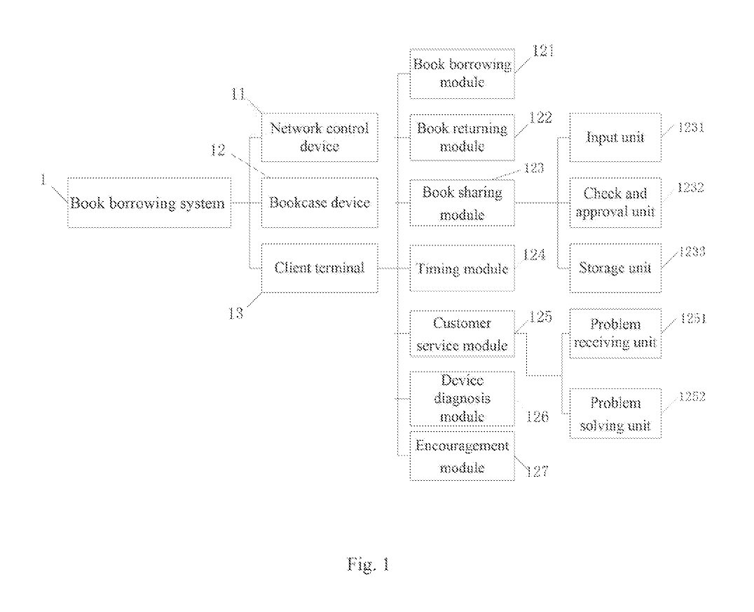

The book self-borrowing system in an embodiment of the present invention can be applied to self-borrowing services of paper reading of books, periodicals, magazines, etc. As shown in FIGS. 1-3, a book self-borrowing system in this embodiment comprises: a network control device 11, a bookcase device 12 and a client terminal 13. The network control device 11 is connected to the client terminal 13 via a local area network, and the network control device 11 is connected to the bookcase device 12 via the local area network. The client terminal 13 may be mobile phone software or computer software. The network control device 11 is a control apparatus of a computer or a tablet computer, etc. The bookcase device 12 comprises a book borrowing module 121, a book returning module 122, a book sharing module 123, a timing module 124, a customer service module 125 and a device diagnosis module 126. A user borrows a book via the book borrowing module 121, and returns the book via the book returning module 122 after finishing reading. The user may also put a personal idle book in the bookcase device via the book sharing module 123. The timing module 124 is used for recording and calculating the time during which the user borrows a book.

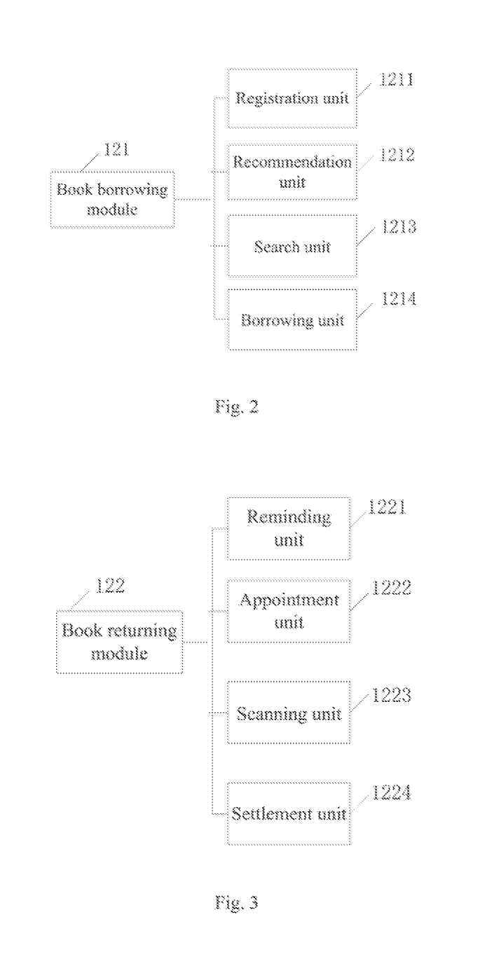

As shown in FIG. 2, the book borrowing module 121 comprises: a registration unit 1211, a recommendation unit 1212, a search unit 1213 and a borrowing unit 1214. When an operator puts a book into circulation at the bookcase device, the registration unit 1211 is used for performing an initial registration on the book which has been put into circulation, wherein the initial registration comprises recording and registering a cover photo, a table of contents and an identification code of the book and a book placing location, and the registration unit 1211 has a built-in memory, and stores the cover photo, the table of contents and the identification code of the book and the book placing location in the memory; the recommendation unit 1212 is used for performing popularity ranking on books according to the number of times the books were borrowed, the book popularity ranking being from high to low, and the recommendation unit 1212 determines a list of recommended books according to the book popularity ranking, wherein the books in the list of recommended books may be top 10 in the book popularity ranking, and if the selected recommended books are too few, the user would have fewer choices, while if the selected recommended books are too many, the meaning of recommending boutique books would be lost; and the search unit 1213 is used for searching for and locating the location of a book desired by a user and locating the specific position of the book which the user looks for. The user uploads identity information via the client terminal 13; the client terminal 13 sends the user identity information to the bookcase device 12; and the bookcase device 12 receives the user identity information. The borrowing unit 1214 reads the user identity information. The borrowing unit 1214 is used for performing identity identification authentication on the user and controlling an intelligent bookcase to unlock an electronic lock. When the user borrows a book, the borrowing unit 1214 is used for performing user identity information authentication, and after the identity information authentication is passed, controlling the intelligent bookcase to unlock the electronic lock. The door of the intelligent bookcase opens and the user obtains the book, and the door of the bookcase is closed after the user gets the book. When the user returns a book, the borrowing unit 1214 again performs authentication on user identity information and book information according to the user identity information and book information scanned by a scanning unit. After the authentication is passed, the borrowing unit 1214 controls the intelligent bookcase to unlock the electronic lock. The door of the intelligent bookcase opens and the book is put into the bookcase smoothly for returning.

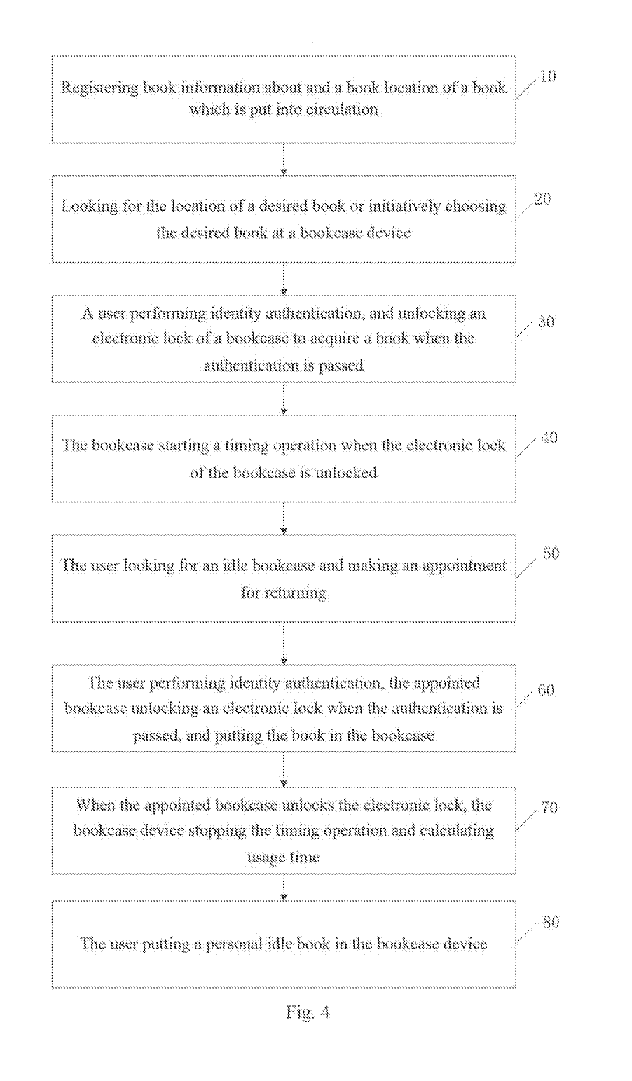

As shown in FIG. 3, the book returning module 122 comprises a reminding unit 1221, an appointment unit 1222, a scanning unit 1223 and a settlement unit 1224. The reminding unit 1221 is used for reminding a user to return a book; the appointment unit 1222 is used for looking for an idle intelligent bookcase and making an appointment for returning; the scanning unit 1223 is used for scanning identity information about a returned book; and the settlement unit being used for settling an amount that needs to be paid according to book borrowing time.

As shown in FIG. 1, the book sharing module 123 comprises an input unit 1231, a check and approval unit 1232 and a storage unit 1233. The input unit 1231 is used for inputting identity information about an idle book that needs to be shared by a user to obtain idle book information, the input of the identity information about an idle book being a user input of a cover photo, a table of contents and an identification code of the book, and the identification code being a cover label identification code of an idle book such as a bar code, a QR code; the check and approval unit 1232 is used for checking and approving the idle book information and screening out qualified idle book information; the storage unit 1233 is used for storing the qualified idle book information which has been screened out; and the bookcase device 12 arranges a personnel to put an idle book corresponding to the qualified idle book information into circulation, so that a personal idle book of a user is better utilized and the usage rate of the idle book is improved. The timing module 124 is used for timing and calculating book borrowing time. When the bookcase device 12 unlocks an electronic lock, the timing module 124 starts a timing operation, and when a bookcase appointed by a book unlocks an electronic lock, the timing module 124 stops the timing operation and calculates book borrowing time, and the settlement unit 1233 settles an amount that needs to be paid according to the book borrowing time. The bookcase device comprises a customer service module 125, the customer service module 125 comprising a problem receiving unit 1251 and a problem solving unit 1252, the problem receiving unit 1251 being used for receiving a problem feedback provided by a user and sending same to the problem solving unit 1252, and the problem solving unit 1252 being used for receiving the problem feedback provided by the user and sending same to a system maintenance personnel. The bookcase device further comprises a device diagnosis module 126, the device diagnosis module 126 being used for autonomously diagnosing a system failure. The device diagnosis module 126 checks whether the running of devices of the bookcase device has failed periodically, and if so, the device diagnosis module 126 feeds the failure back to the maintenance personnel for timely maintenance by same. The bookcase device 12 further comprises an encouragement module 127, the encouragement module 127 being used for querying the number of times a user borrows books and the number of idle books shared by the user via the book borrowing module 121 and the hook sharing module 123, and performing an encouragement operation on the user according to the number of times the user borrows books and the number of idle books shared by the user. The encouragement operation is prolonging free book borrowing time of the user. The encouragement operation may also be giving a material gift reward or reward points to the user. According to the quantity of reward points, the user may exchange the reward points for different gifts. The encouragement operation may also be performing a written praise at the bookcase device 12 or giving a cash bonus reward to the user via the client terminal. The user may acquire the encouragement operation of the encouragement module 127 by increasing the number of times of borrowing books or increasing the times of sharing idle books, so that the user is more keen to read books and share idle books.

The system provided in the disclosed embodiments of the present invention may be launched in densely populated places in batches, such as metro entrances, commercial streets, train stations and entrances and exits of malls, so that it would be more convenient for users to borrow books and share personal idle books.

By means of the system provided in the disclosed embodiments of the present invention, a user may upload identity information about a personal idle book to a bookcase device via a client terminal and a network terminal, and the bookcase device arranges the personnel to put a qualified idle book into circulation after completing check and approval, so that the personal idle book of the user is more utilized, and the usage rate of the idle book is improved.

Based on the book self-borrowing system above, the present invention further provides a book self-borrowing method. As shown in FIG. 4, the method comprises the following steps:
step 10: a bookcase device performing initial registration on a book which has been put into circulation, the initial registration comprising a cover photo, a table of contents and an identification code of the book and a book location, and storing the cover photo, the table of contents, the identification code and the book location;
step 20: a user checking the location of a desired book via a client terminal or initiatively choosing the desired book at a bookcase device, and the user being also able to view a recommended book of the bookcase device via the client terminal, and determining a desired book according to the recommended book
step 30: after the user has found the location of the desired book or determined a book to borrow by choosing at the bookcase device as in step 20, the user performing identity information authentication via the bookcase device, a network control device controlling a bookcase to unlock an electronic lock after the identity authentication is passed, and the user acquiring the book; the identity information comprising authentication of the name, the address, and the contact method of the user;
step 40: the bookcase device starting a timing operation when the network control device controls the bookcase device to unlock an electronic lock;
step 50: the bookcase device reminding the user to return a book via the client terminal, the user looking for an idle bookcase and making an appointment for returning, the step of looking for an idle bookcase and making an appointment for returning comprising: the user looking for an idle bookcase via the client terminal and performing an appointed book returning operation, comprising the user logging in the client terminal and sending an idle bookcase look-for instruction and an appointed returning instruction to the client terminal, and the client terminal sending an idle bookcase instruction and the appointed returning instruction to the bookcase device via the network control terminal;
step 60: when the user returns the book, the bookcase device performing identity information authentication on the user, the network control device controlling an appointed bookcase to unlock an electronic lock after the identity information authentication is passed, and the user putting the book in the bookcase and completing a book returning operation;
step 70: when the user returns the book as in step 60, when the network control device controls an appointed bookcase to unlock an electronic lock and the user puts the book in the bookcase, the bookcase device stopping the timing operation and calculating hook usage time, and the bookcase device settling an amount that needs to be paid according to the book borrowing time; and
step 80: the user inputting identity information about an idle book that needs to be shared, then inputting identity information comprising identity information such as a cover photo, a table of contents and an identification code of the idle book, to obtain idle book information, the bookcase device checking and approving the idle book information and screening out qualified idle book information, and the bookcase device putting the idle book corresponding to the qualified idle book information into circulation.

By means of the method provided in the embodiments of the present disclosure, a user may upload identity information about a personal idle book to a bookcase device via a client terminal and a network terminal, and the bookcase device arranges personnel to put a qualified idle book into circulation after completing check and approval, so that the personal idle book of the user is better utilized, and the usage rate of the idle book is improved.

For those skilled in the art, various other corresponding changes and variations can be made according to the technical solutions and conceptions described above, while all these changes and variations should fall within the scope of protection of the claims of the present invention.

1. A book self-borrowing system, comprising:
a bookcase device, a client terminal and a network control device,
wherein the network control device is connected to the client terminal, the network control device is connected to the bookcase device, and the bookcase device comprises a book borrowing module, a book returning module, a book sharing module and a timing module;
wherein the book borrowing module comprises a recommendation unit, a search unit and a borrowing unit; the recommendation unit is used for performing book popularity ranking according to the number of borrowing times of books, and screening out a recommended book according to the book popularity ranking; the search unit is used for searching for a book desired by a user and locating a position of the book, the borrowing unit is used for performing identity information authentication on the user and controlling an intelligent bookcase to unlock an electronic lock, so that the user obtains the book and returns a book;
the book returning module comprises a reminding unit, an appointment unit and a scanning unit; the reminding module is used for reminding a user to return a book; the appointment unit is used for looking for an idle intelligent bookcase and making an appointment for returning; the scanning unit is used for scanning identity information about a returned book;
the book sharing module comprises an input unit, a check and approval unit and a storage unit; the input unit is used for inputting identity information about an idle book that needs to be shared by a user to obtain idle book information; the check and approval unit is used for checking and approving the idle book information and screening out qualified idle book information; the storage unit is used for storing the qualified idle book information which has been screened out; and
the timing module is used for timing and calculation of hook borrowing time.

2. The book self-borrowing system according to claim 1, wherein the book borrowing module comprises a registration unit, the registration unit being used for performing an initial registration on identity information about a book which has been put into a circulation.

3. The book self-borrowing system according to claim 1, wherein the book returning module further comprises a settlement unit, the settlement unit being used for settling an amount that needs to be paid according to the book borrowing time.

4. The book self-borrowing system according to claim 1, wherein the bookcase device further comprises a customer service module, the customer service module comprising a problem receiving unit and a problem solving unit, the problem receiving unit being used for receiving a problem fed back by the user and sending the problem to the problem solving unit, and the problem solving unit being used for receiving the problem fed back by the user and sending the problem to system maintenance personnel.

5. The book self-borrowing system according to claim 1, wherein the bookcase device further comprises a device diagnosis module and an encouragement module, the device diagnosis module being used for autonomously diagnosing a system failure, and the encouragement module being used for querying the number of times a user borrows books and the number of idle books shared by the user via the book borrowing module and the book sharing module, and performing an encouragement operation on the user according to the number of times the user borrows hooks and the number of idle books shared by the user, the encouragement operation being used for prolonging free book borrowing time of the user and being a gift reward.

6. A book self-borrowing method, comprising:
checking a location of a desired book via a client terminal or initiatively choosing a desired book at a bookcase device by a user;
performing identity information authentication via the bookcase device, controlling a bookcase to unlock an electronic lock by a network control device after the identity authentication is passed, and acquiring the book by the user;
reminding the user to return a book by the bookcase device via the client terminal, looking for an idle bookcase and performing an appointed book returning operation by the user,
when the user returns the book, performing identity information authentication on the user by the bookcase device, controlling an appointed bookcase to unlock an electronic lock by the network control device after the identity information authentication is passed, and putting the book in the bookcase and completing a book returning operation by the user; and
inputting identity information about an idle book that needs to be shared to obtain idle book information by the user, checking and approving the idle book information and screening out qualified idle book information by the bookcase device, and putting the idle book corresponding to the qualified idle book information into a circulation by the bookcase device.

7. The book self-borrowing method according to claim 6, further comprising: performing an initial registration on a book which has been put into the circulation by the bookcase device, the initial registration comprising a cover photo, a table of contents and an identification code of the book and a book location, and storing the cover photo, the table of contents, the identification code and the book location.

8. The book self-borrowing method according to claim 6, further comprising: looking for the idle bookcase via the client terminal and performing the appointed book returning operation by the user,
the step of looking for the idle bookcase comprising logging in the client terminal and sending an idle bookcase look-for instruction and an appointed returning instruction to the client terminal by the user, and sending an idle bookcase instruction and the appointed returning instruction to the bookcase device by the client terminal via the network control terminal.

9. The book self-borrowing method according to claim 6, further comprising:
when the network control terminal controls the bookcase device to unlock the electronic lock, starting a timing operation by the bookcase device,
when the network control device controls the appointed bookcase to unlock the electronic lock, stopping the timing operation, calculating book borrowing time, and settling an amount that needs to be paid according to the book borrowing time by the bookcase device.

10. The book self-borrowing method according to claim 6, further comprising:
viewing a recommended book of the bookcase device via the client terminal, and determining the desired book according to the recommended book by the user.
